(19) United States
(12) Patent Application Publication
(10) Pub. No.: US 2016/0171122 A1
(43) Pub. Date: Jun. 16, 2016

(54) MULTIMODAL SEARCH RESPONSE

(71) Applicant: Ford Global Technologies, LLC, Dearborn, MI (US)

(72) Inventors: Basavaraj Tonshal, Northville, MI (US); Pramita Mitra, Southfield, MI (US); Yifan Chen, Ann Arbor, MI (US)

(73) Assignee: Ford Global Technologies, LLC, Dearborn, MI (US)

(21) Appl. No.: 14/565,823

(22) Filed: Dec. 10, 2014

(51) Int. Cl. G06F 17/30

(52) U.S. Cl. CPC G06F 17/30979; G06F 17/30976

(57) ABSTRACT

A received search query is provided via one of text input and speech input. At least one search topic is identified based on the received search query. The at least one search topic is submitted to a plurality of content databases. Each of the content databases stores a type of content different from any of the other content databases. Received identifying information for at least one content item from at least one of the content databases is displayed. A content item selected according to the displayed identifying information is provided to a user.

### BACKGROUND

Semantic searches use not simply user-provided keywords, but also analyze a search query for context and meaning to better anticipate specific search results that will be of interest to a user. However, some environments permit a search query to be input via a plurality of modes, e.g., text input via a keyboard and voice input via a microphone Further, relevant search results may exist in a variety of modes, e.g., text document, interactive image, audio, video, etc. Accordingly, mechanisms are needed for supporting multi-modal semantic search and/or for supporting multi-modal provision of search results from a semantic search.

### DRAWINGS

FIG. 1 is a block diagram of an exemplary system for multi-modal search query and response.

FIG. 2 illustrates an exemplary process for multi-modal search query and response.

### DETAILED DESCRIPTION

### System Overview

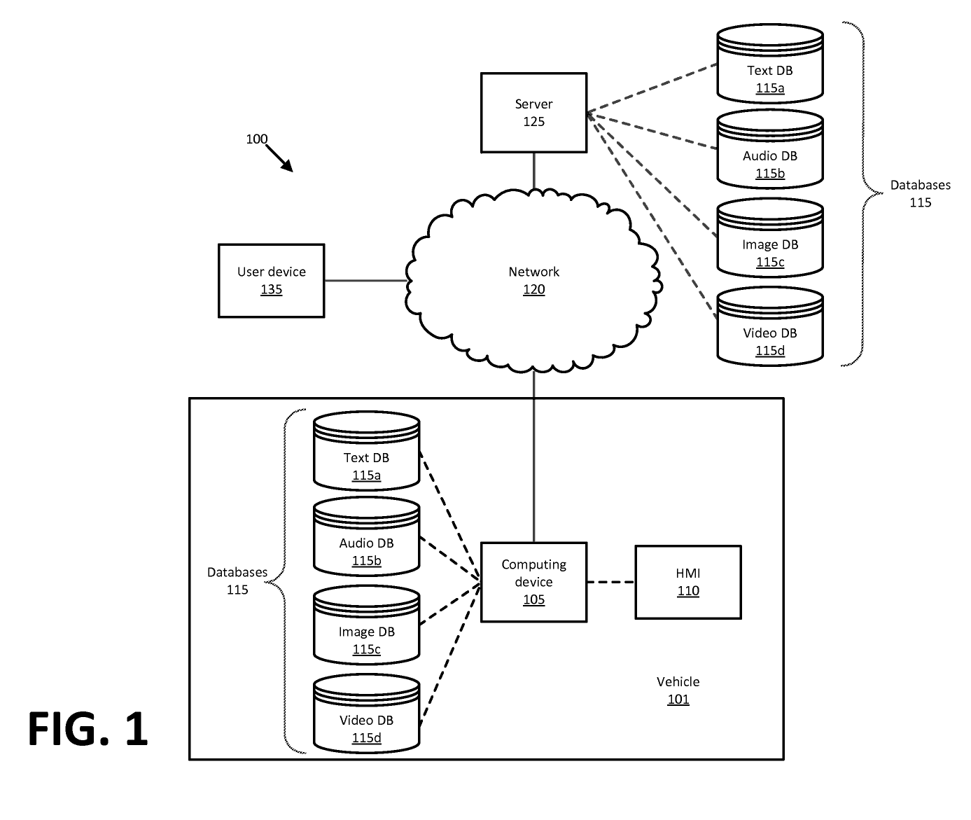

FIG. 1 is a block diagram of an exemplary system 100 for multi-modal search query and response. The system 100 includes a computing device 105, that in turn includes or is communicatively coupled to a human machine interface (HMI) 110. The computing device 105 is programmed to receive a search query via a plurality of input modes, e.g., typed text input, voice input, etc., from the HMI 110. The computing device 105 is further programmed to identify an input mode, and to identify terms for search based on a semantic analysis of the search query, a specific semantic analysis performed being determined at least in part according to the identified input mode. The identified terms can then be searched in a semantic topic index or the like that identifies content that could be included in search results, the content being stored in a plurality of databases 115 according to modes, i.e. formats, of respective content items e.g., a text content database 115a, an audio content database 115b, an image database 115c, and/or a video database 115d, etc. Regardless of content mode, various items of content may be presented together by the HMI 110 for a user selection, and a selected item of content may be provided via an appropriate output mode of the HMI 110 upon the user selection and retrieval from one of the databases 115, e.g., playback of audio, images, or video, etc.

### Exemplary System Elements

The system 100 can be, although need not be, installed in a vehicle 101, e.g., a land-based vehicle having three or more wheels, e.g., a passenger car, light truck, etc. In any case, the computer 105 generally includes a processor and a memory, the memory including one or more forms of computer-readable media, and storing instructions executable by the processor for performing various operations, including as disclosed herein. Further, the computer 105 may include and/or be communicatively coupled to more than one computing device, e.g., controllers or the like included in the vehicle 101 for monitoring and/or controlling various vehicle components, e.g., an engine control unit, transmission control unit, etc.

The computer 105 is generally configured for communications on one or more vehicle 101 communications mechanisms, e.g., a controller area network (CAN) bus or the like. The computer 105 may also have a connection to an onboard diagnostics connector (OBD-II). In implementations where the computer 105 actually comprises multiple devices, the CAN bus or the like may be used for communications between devices represented as the computer 105 in this disclosure. In addition, the computer 105 may be configured for communicating with other devices, such as a smart phone or other user device 135 in or near the vehicle 101, or other devices such as a remote server 125, via various wired and/or wireless networking technologies, e.g., cellular, Bluetooth, a universal serial bus (USB), wired and/or wireless packet networks, etc., at least some of which may be included in a network 120 used for communications by the computer 105, as discussed below.

In general, the HMI 110 is equipped to accept inputs for, and/or provide outputs from, the computer 105. For example, the vehicle 101 may include one or more of a display configured to provide a graphical user interface (GUI) or the like, an interactive voice response (IVR) system, audio output devices, mechanisms for providing haptic output, e.g., via a vehicle 101 steering wheel or seat, etc. Further, a user device, e.g., a portable computing device 135 such as a tablet computer, a smart phone, or the like, may be used to provide some or all of an HMI 110 to a computer 105. For example, a user device could be connected to the computer 105 using technologies discussed above, e.g., USB, Bluetooth, etc., and could be used to accept inputs for and/or provide outputs from the computer 105.

As mentioned above, the computer 105 memory may store stores semantic topic index or the like that generally includes a list of subjects or topics search queries that may be identified using a known technique such as semantic analysis of a search string, i.e., a user-submitted search query. Accordingly, as described further below, a user may submit a search query via one or more modes, e.g., speech or text input, which query is then resolved to one or more topics in the 115, e.g., using a semantic analysis of a submitted search string such as is known. Such topics, e.g., keywords or the like, may be submitted to one or more of the databases 115. The computer 105 may receive a list of search results from one or more of the databases 115, and user may then be presented with a list of content items responsive to a search query, e.g., in a screen of the HMI 110, where the list of content items includes links to each of the one or more items respectively in one of a plurality of different databases 115, each of the items from one of the databases 115 being presented in response to the search query. Advantageously, the provided links are directly retrieve different types of content from different content databases 115a, 115b, 115c, 115d, etc., e.g., a user manual provided as text content from a database 115a as well as user instructions provided in a video from a database 115d, etc.

The databases 115a, 115b, 115c, and 115d may be distinct hardware devices including a computer memory communicatively coupled to the computing device 105, and/or may be portions of a memory or data storage included in the computing device 105. Alternatively or additionally, one or more of the databases 115a, 115b, 115c, and/or 115d, etc. may be included in or communicatively coupled to a remote server 125 that is accessible via a network 120.

The network 120 represents one or more mechanisms by which a vehicle computer 105 may communicate with a remote server 125. Accordingly, the network 120 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The server 125 may be one or more computer servers, each generally including at least one processor and at least one memory, the memory storing instructions executable by the processor, including instructions for carrying out various of the steps and processes described herein. The server 125 may include or be communicatively coupled to or may include databases 115a, 115b, 115c, and/or 115d, as mentioned above.

A user device 135 may be any one of a variety of computing devices including a processor and a memory, as well as communication capabilities. For example, the user device 135 may be a portable computer, tablet computer, a smart phone, etc. that includes capabilities for wireless communications using IEEE 802.11, Bluetooth, and/or cellular communications protocols. Further, the user device 135 may use such communications capabilities to communicate via the network 120 and also directly with a computer 105, e.g., using Bluetooth.

### Exemplary Process Flows

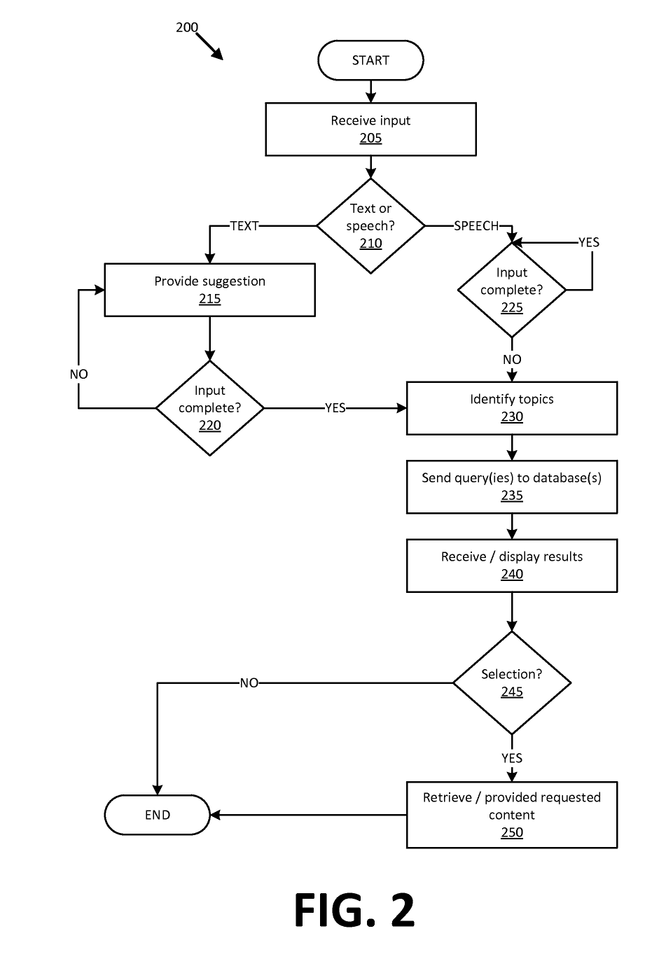

FIG. 2 is a process flow diagram of an exemplary process 200 for multi-modal search query and response. As should be clear from the following description, the process 200 is generally executed according to program instructions carried out by the computer 105, and possibly, in some cases, by program instructions of a remote server 125 and/or user device 135, the computers 125, 135 being communicatively coupled to the computer 105 as described above.

The process 200 begins in a block 205, in which the HMI 110 receives user input of some or all of a search query. For example, the user could begin to enter text in a “search” form field of a graphical user interface provided via the HMI 110 and/or a device 135, or the user could select a button, icon, etc. indicating that the user is going to provide speech input of a search query.

Following the block 205, in a block 210, the computer 105 determines an input mode for the search query that was at least partially received as described above in the block 210. For example, in one implementation, the computer 105 determines whether the input mode is a text input mode or a speech input mode. If the input mode is a text input mode, then the process 200 proceeds to a block 215. If the input mode is a speech input mode, the process 200 proceeds to a block 225.

In the block 215, which may follow the block 210, the computer 105 provides search string suggestions as a user provides textual input, e.g., by typing on a virtual or real computer keyboard included in the HMI 110 and/or a device 135, of a search query. Such search string suggestions may be performed and provided in a known manner, e.g., by a technique that provides suggestions for completing a search query partially entered by a user according to popular searches, a user's location, user profile information relating to a user's age, gender, demographics, etc.

In the block 220, which follows the block 215, the computer 105 determines whether a user's input of a search query is complete. For example, a user may press a button or icon indicating that a search query is to be submitted. If the search query is not complete, then the process 200 returns to the block 215. Otherwise, the process 200 proceeds to a block 230.

In a block 225, which may follow the block 210, the computer 105 determines whether speech input is complete. For example, a predetermined amount of time, e.g., three seconds, five seconds, etc. may elapse without a user providing speech input, a user may select a button or icon indicating that speech input is complete, etc. In any case, if the speech input is complete, then the process 200 proceeds to the block 230. Otherwise, the process 200 remains in the block 225. Note that speech input may be processed using known speech recognition techniques, a speech recognition engine possibly being provided according to instructions stored in memory of the computer 105; alternatively or additionally, a speech file could be submitted to the remote server 125 the of the network 120, whereupon a speech recognition engine in the server 125 could be used to provide an inputted search string back to the computer 105.

In the block 230, the computer 105 identifies topics relevant to the submitted search query, i.e., topics to be submitted to one or more of the databases 115. For example, known semantic search techniques may be used to identify likely user topics of interest based on submitted keywords.

Following the block 230, in a block 235, the computer 105 submits one or more identified topics from the block 230 to one or more databases 115a, 115b, 115c, and/or 115d. Each of the databases 115 may then perform a search for each of the identified topics. For example, each database 115 may include an index or the like, such as is known, correlating content items with keywords or the like.

Following the block 235, in a block 240, the computer 105 receives results, i.e., at least descriptions of content items and links or the like to the content items, from each of the databases 115. Of course, it is possible that a particular database 115 may return the null set, i.e., no search results responsive to a particular query. Further, the computer 105 may receive results from databases 115 included in or associated with the server 125 as well as from databases 115 included in or communicatively coupled to the computer 105 itself. In any event, received results are generally displayed for user selection, e.g., in a display of the HMI 110 and/or in a display of a user device 135.

In one implementation, a class is defined in the C++ programming language to serve as a datatype for each search result. An example of such a C++ class is as follows:

class SearchResult {
public:

```
/**
  * Possible types of a search result.
  */
enum Type {
```

TypeVideo,
TypeAudio,
TypeText,
TypeImage

};
/// Search result type
Type type;
/// The title of this result
std::string title;
/// Extra data that specifies the parameters of the result, such as a

file size. Depends on the type.

std::string actionData;
/// Icon name to display. (Optional)
std::string icon;
SearchResult( ) {
}
SearchResult(Type type, const std::string &title, const std::string

&actionData, const std::string &icon) :

type(type),
title(title),
actionData(actionData),
icon(icon) {

}

};

As can be seen, in this example, search results can be one of four types: video, audio, text, or image. Further, relevant data concerning the type, a title of the content item, and possibly other data such as a file size, video length, etc., can also be displayed along with an optional icon representing the content item. Advantageously, therefore, the HMI 110 and/or user device 135 can display in a single list of search results multiple content items from multiple content databases 115, each of the databases 115 providing content items of a particular type (e.g., video, audio, text, or image).

Following the block 240, in a block 245, the computer 105 determines whether a user selection of a presented content item has been received. For example, the user may have selected a content item using a pointing device, touchscreen, etc., and/or by providing speech input, via the HMI 110 and/or user device 135. If a user selection has been received, then a block 250 is executed next. Otherwise, e.g., if no user selection is received within a predetermined period of time, the computer 105 is powered off, etc., the process 200 ends.

In the block 250, the computer 105 retrieves a requested content item from the respective database 115 storing the content item. Such retrieval may be done in a conventional manner, e.g., by the computer 105 submitting an appropriate query to the respective database 115, either in the memory of the computer 105 and/or to a remote database 115 via the server 125. In any event, once a requested content item has been retrieved and presented to a user, e.g., for playback, display, etc. via the HMI and/or user device 135, the process 200 ends.

### CONCLUSION

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system comprising a computing device that includes a processor and a memory, the memory storing instructions executable by the processor such that the computing device is programmed to:
determine that a received search query is provided via one of text input and speech input;
identify at least one search topic based on the received search query;
submit the at least one search topic to a plurality of content databases, each of the content databases storing a type of content different from any of the other content databases;
display received identifying information for at least one content item from at least one of the content databases; and
providing to a user a content item selected according to the displayed identifying information.

2. The system of claim 1, wherein the computer is further programmed to perform a semantic analysis of the search query to determine the at least one search topic.

3. The system of claim 1, wherein the type of content associated with the each of the content databases includes at least one of text, images, audio, and video.

4. The system of claim 1, wherein the computer is further programmed to determine that input of the search query is complete before identifying the at least one search topic.

5. The system of claim 1, further comprising a remote server that is programmed to receive the search query in a speech file, and to return a text string representing the search query to the computing device.

6. The system of claim 1, further comprising a portable user device communicatively coupled to the computing device, wherein the portable user device is programmed to receive input for the search query, and to provide the input to the computing device.

7. The system of claim 1, wherein the computer is further programmed to provide the selected content item by at least one of playing the selected content item and displaying the selected content item.

8. The system of claim 1, further comprising a portable user device communicatively coupled to the computing device, wherein the computer is further programmed to provide the selected content item by transmitting the selected content item to the portable user device, and the portable user device is programmed to perform at least one of playback and display of the selected content item.

9. The system of claim 1, further comprising a remote server that at least one of includes and is communicatively coupled to at least one of the databases.

10. The system of claim 1, wherein the computing device is installed in a vehicle.

11. A method, comprising:
determining that a received search query is provided via one of text input and speech input;
identifying at least one search topic based on the received search query;
submitting the at least one search topic to a plurality of content databases, each of the content databases storing a type of content different from any of the other content databases;
displaying received identifying information for at least one content item from at least one of the content databases; and
providing to a user a content item selected according to the displayed identifying information.

12. The method of claim 11, further comprising performing a semantic analysis of the search query to determine the at least one search topic.

13. The method of claim 11, wherein the type of content associated with the each of the content databases includes at least one of text, images, audio, and video.

14. The method of claim 11, further comprising determining that input of the search query is complete before identifying the at least one search topic.

15. The method of claim 11, further comprising receiving, in a remote server, the search query in a speech file, and returning a text string representing the search query.

16. The method of claim 11, further comprising, in a portable user device, receiving input for the search query, and transmitting the input.

17. The method of claim 11, further comprising providing the selected content item by at least one of playing the selected content item and displaying the selected content item.

18. The method of claim 11, further comprising providing the selected content item to a portable user device by transmitting the selected content item to the portable user device, wherein the portable user device is programmed to perform at least one of playback and display of the selected content item.

19. The method of claim 11, wherein a remote server is at least one of includes and is communicatively coupled to at least one of the databases.

20. The method of claim 11, implemented in a computing device that is installed in a vehicle.
